(19) United States
(12) Patent Application Publication
(10) Pub. No.: US 2019/0154641 A1
(43) Pub. Date: May 23, 2019

(54) Method and System for Providing Information from a Fraction Collector in a Liquid Chromatography System

(71) Applicant: GE HEALTHCARE BIO-SCIENCES AB, Uppsala (SE)

(72) Inventors: Petra BANGTSSON, Uppsala (SE); Lena NYHOLM, Uppsala (SE); Bengt GORANSSON, Uppsala (SE)

(73) Assignee: GE Healthcare Bio-Sciences AB, Uppsala (SE)

(21) Appl. No.: 16/091,255

(22) PCT Filed: Apr. 6, 2017
(86) PCT No.: PCT/EP2017/058287

§ 371 Date: Oct. 4, 2018

(30) Foreign Application Priority Data
Apr. 6, 2016 (GB) 1605838.0

(51) Int. Cl. G01N 30/82; G01N 30/86; B01D 15/24

(52) U.S. Cl. CPC G01N 30/82; B01D 15/247; G01N 30/8696; G01N 30/8662

(57) ABSTRACT

The present invention relates to a method for providing information from a fraction collector in a liquid chromatography system, the system comprising a column, at least one reservoir for containing a fluid, at least one pump connected to said reservoir, a column arranged to receive an input from the reservoir, a measuring device for performing measurements on a fluid output from the column, and a fraction collector for receiving said fluid output in a plurality of receiving vessels, wherein the method comprises—determining at least one parameter of the fraction collector, and—providing information of said parameter on a display in the form of a graphical representation.

### TECHNICAL FIELD

The present invention relates to a method and system for providing information from a fraction collector in a liquid chromatography system. In particular, but not exclusively, the invention concerns the graphical representation of information relating to fractions collected by a fraction collector downstream of a chromatography system and/or the vessels for collecting the fractions.

### BACKGROUND

Within the field of liquid chromatography, a mixture containing a plurality of substances is generally separated by a column, and a fluid output or eluate from the column is subjected to analysis and subsequently fractioned in a plurality of receiving vessels in a fraction collector. A computer serves as a processing unit and as a user interface and allows the user to adapt and control the process, and the computer also serves to present data and results to the user in the form of a chromatogram with peaks corresponding to different substances in the mixture. The computer display may also present a process picture with symbols for the various parts of the chromatography system and allow the user to control the process to some degree by interacting with the process picture, for instance by clicking on a component to alter its operation.

The possible interactions between the user and the system are, however, often limited and it is not possible to fully determine the state of the chromatography system and its current operation. The user is thereby prevented from making decisions based on these factors and the control of the system becomes cumbersome and unsatisfactory. An improved system and method are therefore desirable.

### SUMMARY OF THE INVENTION

The object of the present invention is to eliminate or at least to minimize the problems described above. This is achieved through a method and system for providing information from a fraction collector in a liquid chromatography system according to the appended independent claims, where at least one parameter of the fraction collector is determined and displayed to allow a user improved insight into the operation of the system.

According to an aspect of the invention, the method further comprises receiving information from the measuring device and providing said information together with the information of the parameter on the display. Thereby, a more detailed understanding of the state of the fraction collector can be achieved and allow an improved interaction between the user and the chromatography system.

According to one aspect of the invention, the method further comprises controlling the system in response to said at least one parameter of the fraction collector and/or said information from the measuring device. Thereby, the user can adjust or alter the system directly in response to information received from the fraction collector.

According to another aspect of the invention, the parameter of the fraction collector can be a position of at least one receiving vessel in the fraction collector or a content of at least one receiving vessel in the fraction collector. Thereby, the user can see the individual receiving vessels and also what part of the eluate or fluid output from the column that is contained in each of the receiving vessels.

According to yet another aspect of the invention, the parameter of the fraction collector is an identification of a receiving vessel currently receiving the fluid output or an identification of a receiving vessel that is arranged to receive the fluid output immediately after the receiving vessel currently receiving the fluid output. Thereby, the user can follow the current operation of the chromatography system and determine how the fluid output currently passing the detector is going to be fractioned.

According to a further aspect of the invention, the parameter is which of the receiving vessels or wells that contain the fluid output. Thereby, the user can see how much of the capacity of the fraction collector that has already been used and also which of the receiving vessels that may be removed and possibly analysed further after the chromatography process is finished.

According to yet another aspect of the invention, the information from the measuring device is an identification of a specific portion of the fluid output and said parameter is which receiving vessel that contains said specific portion. Thereby, the location of any given portion of the eluate can be made known to the user.

According to a further aspect of the invention, the method also comprises determining and displaying a concentration and/or an amount of a substance in said portion. Thereby, additional information on a more detailed level than has previously been possible can be made available to the user.

According to yet another aspect of the invention, the method further comprises combining information of at least two portions of the fluid output and displaying the combined information together with the parameter of which receiving vessels that contain said portions. Thereby, portions of specific interest can be pooled and treated as one during subsequent analysis. This is especially beneficial when pooling the portions corresponding to a peak in the chromatogram but may also be used on other portions. Additionally, a concentration and/or an amount of a substance in said at least two portions may also be determined and displayed.

According to a further aspect of the invention, the method comprises determining and displaying how many receiving vessels that are required for receiving the fluid output of the column, or the number of required receiving vessels compared to the number of receiving vessels currently in the fraction collector. Thereby, the user may determine beforehand if the capacity of the fraction collector is sufficient for the desired run or if additional receiving vessels should be added.

According to yet another aspect of the invention, the method also comprises selecting a receiving vessel in the fraction collector and indicating at least one information in a chromatogram corresponding to a fluid output currently contained in said receiving vessel. Thereby, the user may point to or otherwise mark a specific receiving vessel and in response receive information regarding its contents.

Additional benefits of the invention will become readily apparent to the person skilled in the art in view of the detailed description below.

### DRAWINGS

The invention will now be described in more detail with reference to the appended drawings, wherein:

FIG. 1 discloses a prior art liquid chromatography system;

FIG. 2 discloses a graphical representation for visualising a liquid chromatography system and fraction collector according to a preferred embodiment of the invention;

FIG. 3 discloses a schematic view of a method according to the present invention; and

FIG. 4 discloses a schematic view of a system with a processing unit operatively connected to a liquid chromatography system of the type illustrated in FIG. 2.

### DETAILED DESCRIPTION

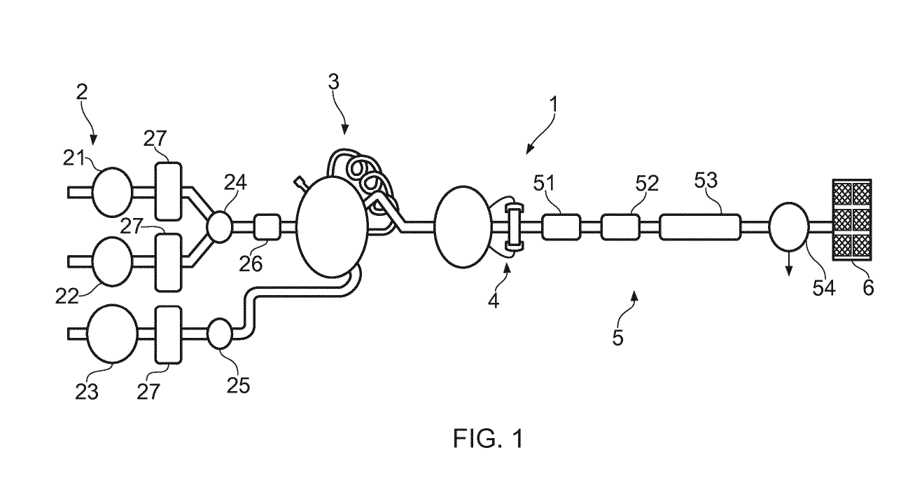

FIG. 1 discloses a liquid chromatography system 1 according to the prior art and will be described in general terms. As is obvious to the person skilled in the art, however, there are a number of variations and modifications available for a liquid chromatography system and these will not be described.

Thus, a liquid chromatography system has an input 2 with reservoirs containing solutions and/or buffers for insertion into a chromatography column 4, said reservoirs connected to inlet valves 21, 22, 23 directing a flow from the reservoirs. The flow is pumped via pumps 27 and passes system pressure detectors 24 and a mixer 26. An injection valve 3 is optionally arranged to control the flow of fluids from the reservoirs to the column 4 and may alternate between injecting solution from a solution reservoir connected to sample inlet valve 23 and injecting buffer from at least one but preferably two or more buffer reservoirs that are connected to buffer inlet valves 21, 22. The buffer thus passes pressure detectors 27 and the pressure detector 24 before being mixed by the mixer 26. The sample is in this system transported to the injection valve 3 via a pump 27 and sample pressure detector 25 but may optionally also be injected into a loop of the injection valve 3. In other liquid chromatography systems the injection valve may also be omitted and the sample and buffer inserted into the column directly.

From the column 4 a fluid output or eluate is analysed by a measuring device 5 that may comprise a plurality of devices for different types of analysis. In FIG. 1, a UV detector 51 is arranged to use UV light to measure absorbance and a conductivity measuring device 52 is arranged to measure conductivity in the fluid output. A flow restrictor 53 is also provided to create a steady backpressure and an exit valve 54 is arranged to direct the fluid output towards a fraction collector 6, where it is fractioned into a plurality of receiving vessels, or alternatively to allow the fluid output to exit the chromatography system without being fractioned. The exit valve may also have other exits, such as a waste exit and a plurality of output exits to divide the flow into larger fractions than would be possible in the fraction collector 6 itself, perhaps into one or more bottles placed adjacent to the system 10. The measuring device 5 may also comprise other detectors such as a pH detector for instance, and serves to monitor the separation process in the column 4 by measuring different properties of the fluid output.

The receiving vessels may for instance be test tubes, wells or bottles, or a combination of these, and serve to collect and hold a fluid in the fraction collector 6.

The inventors have realised that the system described above could be improved by making the usability of the system easier. To this end, a user controlling and monitoring the separation process in the liquid chromatography system may instruct the system and provide set values for parameters such as solution concentration or flow rate by interacting with a processing unit 100 (as shown in FIG. 4) that is generally in the form of a processing unit such as a computer having a display 101 and input means 102 such as a keyboard or a touch screen that are operatively connected to the processing unit 100. The input means 102 may further be a cell phone, a tablet computer or similar.

The processing unit 100 receives input from the system 1 and also provides control signals to the various components of the system 1 disclosed in FIG. 1 and also receives and stores data from the measuring device 5 and can display the data in various forms, for instance as a chromatogram. The prior art system disclosed by FIG. 1 does not, however, detect, store or present data regarding the fraction collector and the fluid output that has been fractioned and thereby prevents a more versatile interaction between the user and the system. It is to be noted that the input 102 may also be connected to the processing unit 100 through a wireless connection such as a network, an internet connection or a cloud connection. The display 101 can also be separate from the processing unit 100 and communicate through a wireless connection. Furthermore, the processing unit 100 may be operatively connected to a plurality of displays 101, at least some of which may be connected by a wireless connection and may be located remotely.

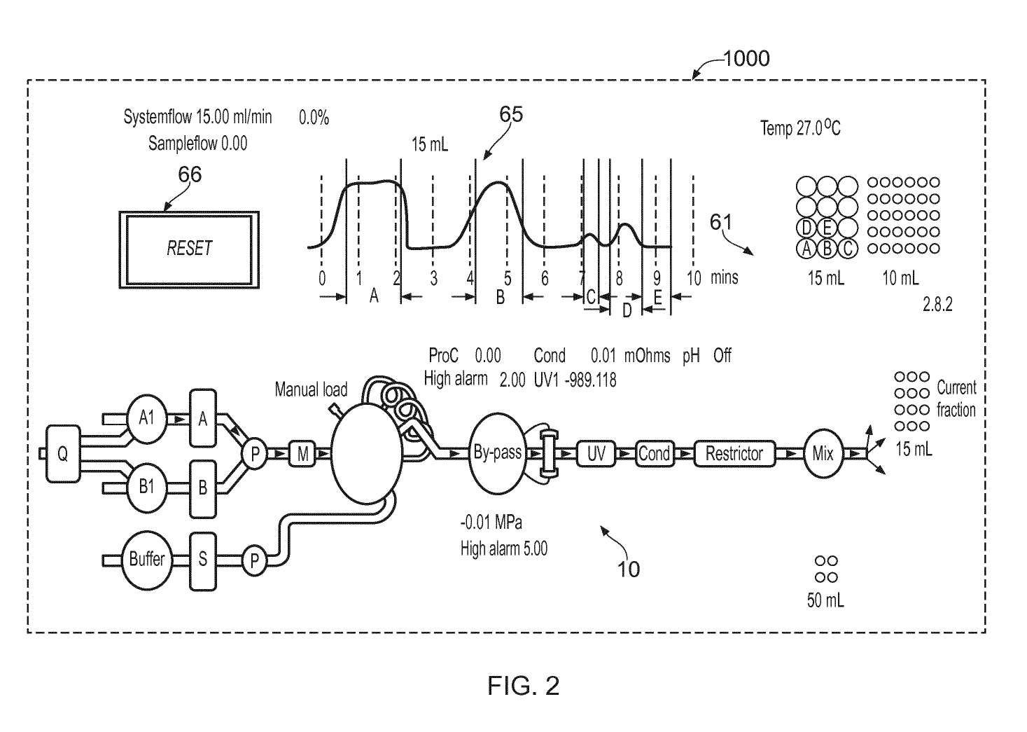

FIG. 2 discloses a typical image 1000 from a graphical representation, displayed on the display 101 and representing a liquid chromatography system 10 similar to the physical system 1 described above. The system 10 generally comprises the components already shown and described in FIG. 1 and is operated in a similar way, but is also arranged to determine and display parameters of the fraction collector 6 and also allows for a combination of such parameters with information from the measuring device 5 to allow an improved interaction of the user with the chromatography system 10. The image 1000 can show the path of fluids in the system 10, in this case by changing the colour of the path which is currently being used, supplemented in this illustration by arrows. An animation could also be used where flow can be shown which appears to move. The fraction collection information 61 in this case can be visualised as alternative arrangements of vessels shown in plan view, with graphical or numerical information beside the plan view providing indications of certain parameters.

Thus, the processing unit 100 receives parameters and displays them on the display 101 in the form of detailed fraction information 61 that forms part of the image 1000 that also includes other features and components of the chromatography systems.

One parameter of the fraction collector 6 can preferably be a position of at least one receiving vessel in the fraction collector and by displaying this in the detailed fraction information 61, the user can identify a specific receiving vessel and see its placement in the fraction collector 6. For example, the user may be provided with a graphical display 62 as part of information 61 displayed on the display 101, in the form of a graphical display showing a labelled plan view of an array of selectable fraction collection vessels. The parameter may alternatively be a content of the receiving vessel, and this parameter may be combined with information from the detectors of the detection device 5 so that detailed information of the content may be presented on the display 101 at the same time as the receiving vessel is identified.

The parameter of the fraction collector can also be an identification of a receiving vessel currently receiving the fluid output or an identification of a receiving vessel that is arranged to receive the fluid output immediately after the test receiving vessel currently receiving the fluid output. For example the display may be animated such that the current position of the vessel receiving fractionated liquid is displayed in real-time, for example[le by changing colour or some other time dependent indication. This allows the user to follow the operation of the liquid chromatography more closely and see how the fluid output passing the detector at a given time is going to be fractioned. The parameter may also be an indication of the receiving vessels or wells that contain the fluid output, to show how many of the receiving vessels that have been used in the current run of the system.

The parameter of the fraction collector 6 and information from the measuring device 5 can also be an identification of a specific portion of the fluid output and an indication of the receiving vessel that contains said specific portion. For example the position of the fraction dispenser 54 can be determined and a relevant X-Y position can be stored in a memory. The data in that memory can be compared with mass flow data from the measurement device 5 to provide an indication of what portion of the fractionated flow was dispensed at what X-Y position. That data when compared to the plan data for the position of each vessel can provide an indication of what portion is in each vessel. Where live concentration data is provided from a spectrophotometer incorporated into the measure device 5, the user may then track any given portion and find out where it is fractioned, and a concentration and/or an amount of a substance in said portion can also be shown in the image 1000 on the display 101. Further the user can select a part of a curve in the chromatogram 65, which is shown as part of the same image 1000, but may be displayed on a different image, for instance a peak in concentration of a protein or the like, and the display then provides data relating to time (1 to 10 minutes here) and any peaks in concentration and also shows in which receiving vessel (A to D) the portion corresponding to that peak is located. It is also possible to select a plurality of receiving vessels, or a part of the chromatogram, and have the system provide a combination of the information or data corresponding to the contents of those receiving vessels or that part of the chromatogram. The combination can be displayed or can be used for subsequent computations to yield further data of interest. Further, the user can select when to switch receiving vessels for example in order to better capture the whole peak of concentration displayed in real time i.e. almost instantaneously as the concentration measurements are performed, recorded and displayed on the display 101. Thus in FIG. 2 the chromatograph 65 illustrates that collection vessel A has been selected to capture an initial peak and vessels B, C and D have been selected to capture succeeding peaks. Those vessels are visualised, in this case to the right of the chromatograph at the fraction information area 61. Other vessels can accommodate the fractionated flow between the peaks of concentration which are of lesser interest. In this case the current vessel is vessel E.

To facilitate the planning of a run of the chromatography system, it can be shown how many receiving vessels that are required for a specific run given the amount of fluid input to the column 4, and it can also be shown how many receiving vessels that are already provided in the fraction collector 6. The user can then decide if additional receiving vessels need to be added before the process or run begins. To provide information for this parameter the receiving vessels used will be identified and by matching data relating to the capacity of the vessels with the identification data it is possible to calculate the total receiving capacity of the vessels used. Further data relating to the total expected volume of liquids used in a chromatographic process can be used to determine the number of those vessels needed before a run starts. To provide such data the vessels can be scanned using a technique described in U.S. Pat. No. 8,726,944 where the a multi-well receiving vessel need not have identification means, but rather is scanned in X and Y directions to count the number of well present, and an estimation of its capacity can be made if the capacity of each well is estimated. If the capacity of each well is known then the capacity can be determined with more accuracy. The contents of U.S. Pat. No. 8,726,944 are incorporated herein by reference. Thereby, the means for determining the parameter of the fraction collector 6 preferably comprises at least one optical scanner mounted inside the fraction collector. Preferably, the optical scanner can move in two dimensions (i.e. in a plane) and thereby scan all the receiving vessels from above. The means for determining the parameter may also comprise other sensors and may comprise embedded software in the fraction collector that controls the fractioning into the receiving vessels.

By giving input to the input means, i.e. to the keyboard, touch screen or mouse, the user can select a receiving vessel and the processing unit 100 can display information relating to the contents of that receiving vessel on the display 101, either at image 1000, or using a pop-up window overlying image 1000, or on a separately displayed image.

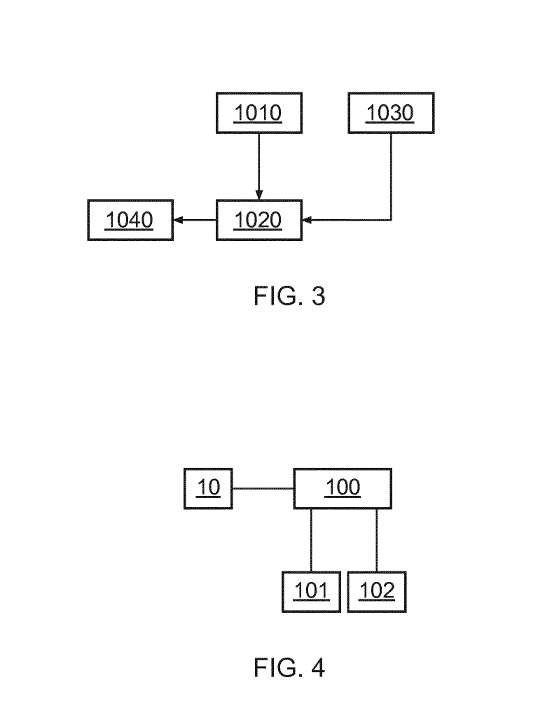

Thus, as disclosed in FIG. 3, the method of the present invention comprises determining 1010 at least one parameter of the fraction collector 6 and providing 1020 information of said parameter on a display 101. Means for determining the parameter may comprise a sensor or an optical detector present in the fraction collector and may also comprise a detector arranged to determine a flow of the fluid output into the fraction collector 6. The means for determining the parameter can also include a sensor or the like for determining the movement of an arm or similar to achieve an insertion of the fluid output into a specific receiving vessel. The method also comprises receiving 1030 information from the measuring device 5 and displaying this information together with the parameter from the fraction collector 6.

The information from the detection device 5 can be any information from any of the detection means present in the detection device 5, such as an absorbance, concentration, substance amount, pH or conductivity, among others.

Other parameters of the fraction collector 6 may also be determined, such as for instance a ratio between different UV wavelengths, purity of a portion of the fluid output, result from other monitors and ratios or calculated number based on other curves shown on the display.

The method of the present invention can also comprise controlling 1040 the system 10 in response to said at least one parameter of the fraction collector 6 and/or said information from the measuring device 5. This gives the user the opportunity to control the fraction collector 6 directly and also to control and modify other parts of the system, for instance by selecting into which receiving vessels the fluid output is to be fractioned and also determine the order of receiving vessels to be used subsequently. The user can also select settings for the fraction collector 6, ask the processing unit 100 to combine or pool the contents of a plurality of receiving vessels and perform calculations on the resulting combination or pool. This control can be done in real time if desired. Furthermore, the user can select parameters for subsequent calculations or analysis and in general control or alter all the parameters of the fraction collector.

One arrangement for performing the user control mentioned above is to provide areas of the image 1000 which represent user input areas, and so by either hovering a cursor over those areas, or touching those areas, the user can control the system's 10 operation. One example of an instructional user input area is a RESET area 66 shown in FIG. 2 where an instruction to reset the parameters determined can be input, for example once a chromatography run has been completed. In practice the input means 102 and the display 101 shown in FIG. 4 may be the same component, for example a touch screen, or may work in tandem, for example a mouse used to select different instructional areas on the screen.

The invention also comprises a computer program product arranged to be provided in a system for providing information from a fraction collector in a liquid chromatography system as described above. The computer program product is preferably stored and executed on the processing unit 100 and comprises instructions for causing the processing unit to perform the method steps of the method disclosed above.

1. A method for providing information from a fraction collector in a liquid chromatography system, the system comprising a column, at least one reservoir for containing a fluid, at least one pump connected to said reservoir, a column arranged to receive an input from the reservoir, a measuring device for performing measurements on a fluid output from the column, and a fraction collector for receiving said fluid output in a plurality of receiving vessels, wherein the method comprises
determining at least one parameter of the fraction collector, and
providing information relating to said parameter in the form of a graphical representation on a display.

2. The method according to claim 1, wherein the method further comprises receiving information from said measuring device and providing said information together with the information of the parameter on the display.

3. The method according to claim 1, wherein the method further comprises controlling the system in response to said at least one parameter of the fraction collector and/or said information from the measuring device said controlling being provided by user input, optionally during chromatographic operation of said system.

4. The method according to claim 1, wherein said at least one parameter is a position of at least one receiving vessel in the fraction collector.

5. The method according to claim 1, wherein said at least one parameter is a content of at least one receiving vessel in the fraction collector.

6. The method according to claim 1, wherein said at least one parameter is an identification of a receiving vessel currently receiving the fluid output or an identification of a receiving vessel that is arranged to receive the fluid output immediately after the test receiving vessel currently receiving the fluid output.

7. The method according to claim 1, wherein said at least one parameter is a determination of which of the receiving vessels or wells contain the fluid output.

8. The method according to claim 1, wherein said information from the measuring device is an identification of a specific portion of the fluid output and said parameter is which receiving vessel that contains said specific portion.

9. The method according to claim 8, further comprising determining and displaying a concentration and/or an amount of a substance in said portion.

10. The method according to claim 8, further comprising combining information of at least two portions of the fluid output and displaying the combined information together with the parameter of which receiving vessels that contain said portions.

11. The method according to claim 10, further comprising determining and displaying a concentration and/or an amount of a substance in said at least two portions.

12. The method according to claim 1, further comprising determining and displaying how many receiving vessels are required for receiving the fluid output of the column.

13. The method according to claim 12, further comprising determining and displaying the number of required test receiving vessels compared to the number of receiving vessels currently in the fraction collector.

14. The method according to claim 12, further comprising selecting a receiving vessel in the fraction collector and indicating at least one information in a chromatogram corresponding to a fluid output currently contained in said receiving vessel.

15. A chromatography system for providing information from a fraction collector, the system comprising a column, at least one reservoir for containing a fluid, at least one pump connected to said reservoir, a column arranged to receive an input from the reservoir, a measuring device for performing measurements on a fluid output from the column, and a fraction collector for receiving said fluid output in a plurality of receiving vessels, and further comprising
means for determining at least one parameter of the fraction collector, and
a display arranged to receive and display information relating to said parameter in the form of a graphical representation.

16. The system according to claim 15, further comprising a processing unit operatively connected at least to the measuring device and the fraction collector.

17. The system according to claim 15, wherein the means for determining at least one parameter of the fraction collector comprises at least one optical scanner.

18. A computer program product arranged to be provided in a system for providing information from a fraction collector in a liquid chromatography system, the system comprising a column, at least one reservoir for containing a fluid, at least one pump connected to said reservoir, a column arranged to receive an input from the reservoir, a measuring device for performing measurements on a fluid output from the column, a fraction collector for receiving said fluid output in a plurality of receiving vessels, and a processing unit operatively connected to the fraction collector and the measuring device, said computer program product comprising instructions for causing the processing unit to perform the method steps of:
determining at least one parameter of the fraction collector, and
providing information relating to said parameter on a display in the form of a graphical representation.

19. A method, system or program as claimed in claim 18, wherein the graphical representation is animated, to show fluid flow, and/or real time changes in said parameters or information.

20. A method, system or program as claimed in claim 18, wherein the graphical representation includes one or more instructional areas allowing user input to control the system in real time.
